(19) United States
(12) Patent Application Publication
(10) Pub. No.: US 2016/0264164 A1
(43) Pub. Date: Sep. 15, 2016

(54) SYSTEMS AND METHODS FOR AN INTERLOCKING WAGON

(71) Applicant: TYLER HULL, Lincoln, NE (US)

(72) Inventor: TYLER HULL, Lincoln, NE (US)

(21) Appl. No.: 15/066,904

(22) Filed: Mar. 10, 2016

Related U.S. Application Data
(60) Provisional application No. 62/132,186, filed on Mar. 12, 2015.

(51) Int. Cl. B62B 3/02

(52) U.S. Cl. CPC B62B 3/027

(57) ABSTRACT

Embodiments disclosed herein describe systems and methods for an interlocking wagon. In embodiments, the interlocking wagon may include a first component and a second component, wherein each component is coupled to a set of wheels.

### CROSS-REFERENCE TO RELATED APPLICATIONS

This application claims a benefit of priority under 35 U.S.C. §119 to Provisional Application No. 62/132,186 filed on Mar. 12, 2015, which is fully incorporated herein by reference in its entirety.

### BACKGROUND INFORMATION

1. Field of the Disclosure

Examples of the present disclosure are related to systems and methods for an interlocking wagon. More particularly, embodiments relate to a wagon with a first component and a second component, wherein the first component and second component may be coupled and decoupled from one another.

2. Background

Conventionally wagons are four wheeled vehicles that are propelled by human power via a handle. Typically, wagons include an open-top cuboid compartment for holding and transporting objects. These wagons include two sets of wheels, wherein one set of wheels is able to pivot in a manner that allows the wagon to be steered.

Additionally, some wagons are configured to be collapsible. Collapsible wagons typically include a hinge that allows the wagon to fold over itself. When a collapsible wagon is folded over itself, the length of the wagon is reduced. However, when folded, the height of the collapsible wagon increases, which results in the cubic volume occupied by the collapsible wagon to remain constant. This leads to difficulties when storing collapsible wagons in either the folded or unfolded state.

Furthermore, when a collapsible wagon is folded, the wagon is maintained in a unitary piece. Therefore, different components of conventional wagons may not be separated and used simultaneously.

Accordingly, needs exist for more effective and efficient systems and methods for a detachable wagon, wherein a first component of the wagon is configured to be separable from a second component of the wagon.

### SUMMARY

Embodiments disclosed herein describe systems and methods for an interlocking or detachable wagon. In embodiments, the interlocking wagon may include a first component and a second component, wherein each component includes its own axel with a set of wheels. In embodiments, the first component and the second component may be separable and may be used simultaneously and independently of each other.

In a first mode of operation, the first component and the second component of the wagon may be configured to be interlocked together. When the first component and the second component of the wagon are interlocked, the wagon may form an integrated wagon. In embodiments, when the first component of the wagon and the second component of the wagon are interlocked, objects may be positioned within a compartment, wherein the compartment of the integrated wagon may defined by the sidewalls of the first component and the second component of the wagon. When the first component of the wagon and the second component of the wagon are interlocked, the wagon may be configured to transport the objects positioned within the compartment to various locations.

In embodiments, to interlock the first component of the wagon and the second component of the wagon, arms associated with the first component of the wagon may be positioned adjacent to platforms positioned on the second component of the wagon. Furthermore, projections positioned on the first component of the wagon may be configured to interface with grooves positioned on a lower surface of the second component of the wagon. Responsive to interfacing the projections with the grooves, the first component of the wagon and the second component of the wagon may be coupled or interlocked.

In a second mode of operation, the first component of the wagon may be configured to be decoupled from the second component. In the second mode, both components of the wagon may be utilized simultaneously. To decouple the first component of the wagon and the second component of the wagon, the first component of the wagon may be tilted. When the first component is tilted, the arms on the first component of the wagon may be positioned away from the platforms on the second component of the wagon. Additionally, when the first component of the wagon is tilted, the projections on the first component of the wagon may disconnect from the grooves on the second component of the wagon. Then, the first component of the wagon may be slid towards a first end of the wagon to disconnect the first component of the wagon from the second component of the wagon.

In embodiments, responsive to decoupling the first component of the wagon from the second component of the wagon, the first component of the wagon and the second component of the wagon may each form raised platforms, wherein each of the set of wheels may raise the platforms. Therefore, when decoupled, the first component of the wagon and the second component of the wagon may be utilized to play a game, such as corn hole, bean bag toss, washers, etc.

In embodiments, when the first component of the wagon and the second component of the wagon are disconnected, the first component of the wagon and the second component of the wagon may individually occupy less space than a unitary wagon. Therefore, storage of the individual first component and second component of the wagon may be more convenient.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts an interlocking wagon, according to an embodiment.

FIG. 2 depicts a first component of an interlocking wagon, according to an embodiment.

FIG. 3 depicts a second component of an interlocking wagon, according to an embodiment.

FIG. 4 depicts an interlocking wagon when a first component and a second component are coupled together, according to an embodiment.

FIG. 5 depicts decoupling a first component and a second component of an interlocking wagon, according to an embodiment.

FIG. 6 depicts a first component and a second component of an interlocking wagon being completely separated, according to an embodiment.

FIG. 7 depicts a method for coupling components of an interlocking wagon, according to an embodiment.

FIG. 8 depicts a fully assembled wagon, according to an embodiment.

FIG. 9 depicts side rails associated with an integrated wagon, according to an embodiment.

FIG. 10 depicts a first part of the side rails, according to an embodiment.

FIG. 11 depicts a flatbed wagon, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Embodiments disclose an interlocking wagon. The interlocking wagon may be configured to hold and transport objects from a first location to a second location. Furthermore, the interlocking wagon may be configured to be disconnected into a first component and a second component. Responsive to disconnecting the first component of the wagon and the second component of the wagon, the components may be utilized individually for a game and/or stored individually.

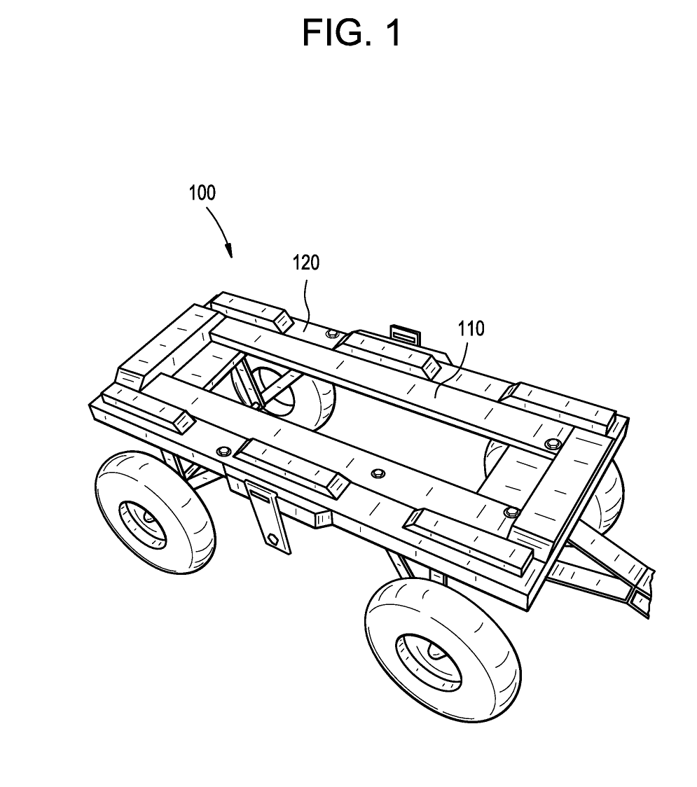

Turning now to FIG. 1, FIG. 1 depicts one embodiment of interlocking wagon 100. Interlocking wagon 100 may include first component 110 and second component 120. In a first mode of operation, first component 110 and the second component 120 of the interlocking wagon 120 may be configured to be coupled together. When first component 110 and second component 120 of the interlocking wagon 100 are coupled together, then the wagon may form an integrated wagon.

In a second mode of operation, as depicted in FIG. 1, first component 110 of interlocking wagon may be configured to be decoupled from second component 120. In the second mode of operation, first component 110 and second component 120 of interlocking wagon 100 may be utilized simultaneously.

As depicted in FIG. 1, first component 110 and second component 120 may be asymmetrical pieces, wherein both pieces may have a hollow center. For example, when coupled together, first component 110 and second component 120 may have an open strip extending through the longitudinal axis of interlocking wagon 100.

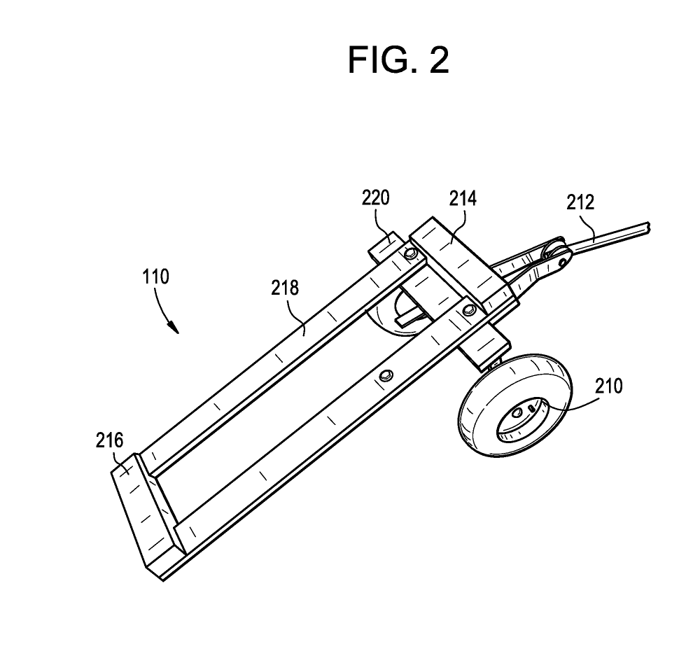

FIG. 2 depicts one embodiment of first component 110 of interlocking wagon 100. First component 110 of interlocking wagon 100 may include a first set of wheels 210, handle 212, front sidewall 214, rear sidewall 216, arms 218, and projections 220.

First set of wheels 210 may be a front set of wheels for interlocking wagon 100, wherein first set of wheels 210 is configured to assist in the movement of interlocking wagon 100 from a first location to a second location. First set of wheels 210 may be comprised of rubber, plastics, wood, metal, etc. In embodiments, first set of wheels 210 may include an axle that allows interlocking wagon 100 to be steered in different directions.

Handle 212 may be coupled to the axle of first set of wheels 210. Additionally, handle 212 may be configured to be held by a user of interlocking wagon 100. Responsive to a user applying force to handle 212, interlocking wagon 100 may be moved and steered.

Front sidewall 214 may be positioned at a first end of interlocking wagon 100, wherein front sidewall 214 may define a front boundary of a compartment formed within interlocking wagon 100. In embodiments, front sidewall 214 may be disposed at a positioned elevated above first set of wheels 210.

Rear sidewall 216 may be positioned at a second end of interlocking wagon 100, wherein rear sidewall 216 may define a rear boundary of the compartment formed within interlocking wagon 100. In embodiments when first component 110 and second component 120 are coupled together, rear sidewall 216 may be secured at a position elevated above a second set of wheels, wherein the second set of wheels are associated with second component 120. In embodiments when first component 110 and second component 120 are decoupled, rear sidewall 216 may be positioned adjacent to a floor surface.

Secured to rear sidewall 216 may be a rear handle (not shown in FIG. 1), wherein the rear handle may be configured to allow a user to move first component 110 when first component 110 and second component 120 are decoupled.

Arms 218 may be configured to extend from front sidewall 214 to rear sidewall 216. A first arm 218 may be positioned on a first side of first component 110, and a second arm 218 may be positioned on a second side of first component 110. Arms 218 may be symmetrical arms that run parallel to each other, wherein arms 218 may form component of a floor for the compartment within interlocking wagon 100. Furthermore, arms 218 may have a planar top surface and bottom surface, wherein the planar top surface is configured to slide in-between the platforms on second component 120. In embodiments, there may be an opening between the set of arms 218.

In embodiments, arms 218 may be configured to be positioned adjacent to platforms on second component 120 of interlocking wagon 100 when first component of interlocking wagon 100 is coupled with second component 120 of interlocking wagon 100. Arms 218 may have a first width, which may be smaller than a second width associated with front sidewall 214 and rear sidewall 216. By arms 218 having the first width, arms 218 may be configured to slide into second component 120, while limiting front sidewall 214 and rear sidewall 216 to be decoupled from second component 120 unless first component 110 or second component 120 is tilted.

Projections 220 may be protrusions extending away from arms 218, wherein projections 220 may extend away from arms 218 in a direction that is perpendicular to arms 218. Projections 220 may be positioned proximate to front sidewall 214 and be positioned over first set of wheels 210. In embodiments, projections 220 may be configured to interface with grooves positioned within second component 120 of interlocking wagon 100. Responsive to coupling projections 220 with the grooves, first component 110 and second component 120 of interlocking wagon 100 may be coupled together.

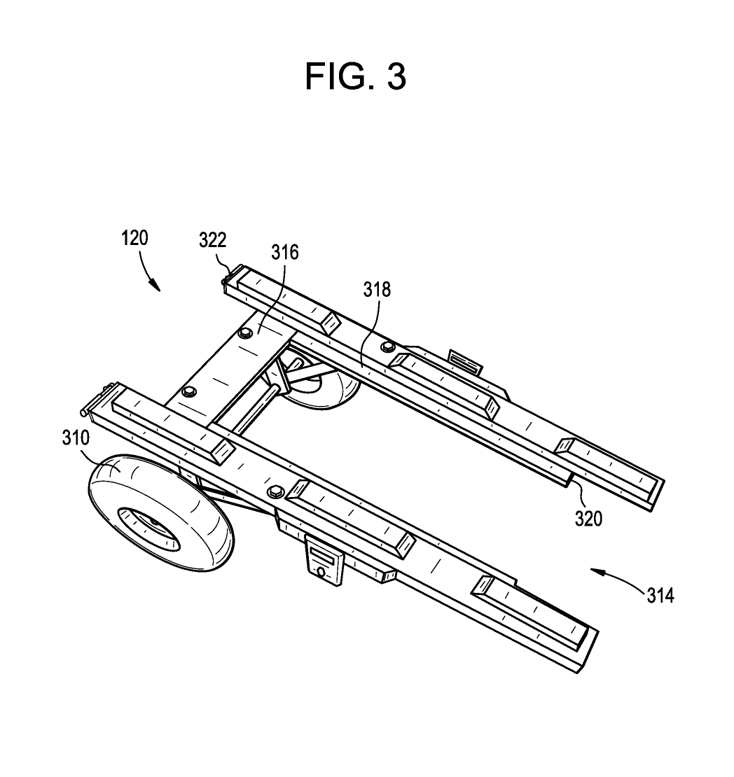

FIG. 3 depicts one embodiment of second component 120 of interlocking wagon 100. Second component 120 of interlocking wagon 100 may include a second set of wheels 310, second handle or open end 314, rear platform 316, side platforms 318, and grooves 320.

Second set of wheels 310 may be a rear set of wheels for interlocking wagon 100, wherein second set of wheels 310 is configured to assist in the movement of interlocking wagon 100 from a first location to a second location. Second set of wheels 310 may be comprised of rubber, plastics, wood, metal, etc. Second set of wheels 310 may be positioned at a second end of interlocking wagon 100, wherein first set of wheels 210 may be positioned at a first end of interlocking wagon 100. In embodiments, first set of wheels 210 and second set of wheels 310 may be positioned at the same height. Therefore, when first component 110 and second component 120 of interlocking wagon 100 are coupled together, the bottom surface of the compartment formed within interlocking wagon 100 may be parallel to a ground surface.

In embodiments, a second end of second component 120 may include an open end or a second handle 314. In embodiments, with an open end 314, there may be an opening between sets of side platforms 318. Via the open end 314, first component 110 may be slid away from second component 120.

In embodiments with a second handle (not shown) positioned at a second end of second component 120, second handle may extend across the width of second component 120 of interlocking wagon 100. Second handle may be configured to be held by a user of interlocking wagon 100 when second component 120 is detached from first component 110. Responsive to a user applying force to second handle, second component 120 of interlocking wagon 100 may be moved and steered. Second handle may be configured to project away from side platforms 318, and a width of the second handle may be greater than a width between side platforms 318.

Rear platform 316 may be positioned proximate to a second end of interlocking wagon 100, and may extend across the width of second component 120. When first component 110 and second component 120 of interlocking wagon 100 are coupled together, arms 218 may be configured to be positioned on and extend across rear platform 316. Accordingly, when first component 110 and second component 120 are coupled together, rear platform 316 may be configured to support arms 218.

Side platforms 318 may be configured to extend from a position proximate to the first end towards a position proximate to the second end of second component 120. Side platforms 318 may be configured to be sidewalls, channels, slots, etc. that arms 218 may slide onto. In embodiments, when arms 218 are slid into second component 120, the outer surfaces of arms 218 may be positioned on side platforms 318. Accordingly, side platforms 318 may guide arms 218 while being slid into second component 120. In embodiments, there may be an opening between the side platforms 318. The opening between side platforms 318 may be a greater distance than the opened between arms 218. In embodiments, side platforms 318 may not extend along the entire longitudinal axis of second component 120.

There may be no side platforms 318 between the second end of second component 120 and rear platform 316, such that rear sidewall 216 of first component 110 may be positioned between the second end of second component 120 and rear platform 316. When rear sidewall 216 is positioned between the second end of second component 120 and rear platform 316, a portion of rear sidewall 216 may be positioned adjacent to rear platform 316. This adjacent portion of rear sidewall 216 and rear platform 316 may limit the forward movement of first component 110 while first component 110 and second component 120 are coupled together.

In further embodiments, locking mechanisms 322 may be positioned on the second end of second component 120, which may be proximate to wheels 310. The locking mechanisms 322 may be any type of fastening device that is configured to couple first component 110 and second component 120. In embodiments, components of locking mechanisms 322 may be configured to slide into lock receivers positioned on rear sidewall 216. Responsive to the components of locking mechanisms 322 being slid into the lock receivers, the first component 110 and second component 120 may be securely coupled together at the second end of interlocking wagon 100.

Grooves 320 may be slots, depressions, notches, etc. positioned on lower surfaces of the first end of side platforms 318, wherein the first end is proximate to handle 314. Grooves 320 may be positioned along a portion of second component 120 that do not include side platforms 318. Grooves 320 may be formed to be substantially the same inverse shape as projections 220. Grooves 320 may be formed at the boundary of side platforms 318, wherein when arms 218 are slid into side platforms 318, projections 220 may be positioned within grooves 320 to couple first component 110 and second component 120.

Accordingly, when projections 220 are positioned within grooves 320, force applied to the first end of interlocking wagon 100 may be transferred to projections 220. Furthermore, when projections 220 are interfaced with grooves 320, force applied to the second end of interlocking wagon may be transferred to rear platform 316. To this end, both the first component 110 and second component 120 may be configured to support objects positioned within a compartment of interlocking wagon 100 when first component 110 and second component 120 are coupled together.

Responsive to tilting rear sidewall 216, rear sidewall 216 may slide through the open end 314, the projections 220 may be positioned away from grooves 320, and first component 110 may slide away from second component 120.

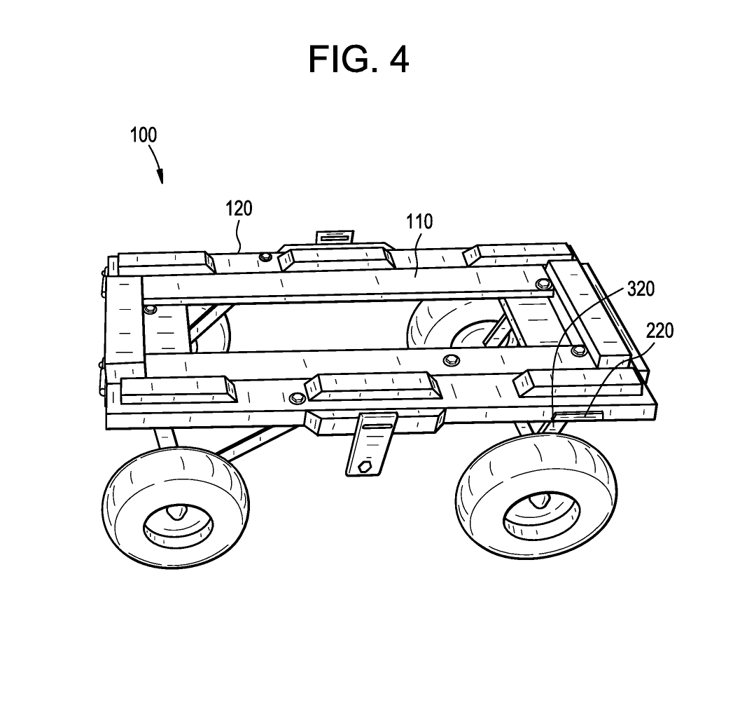

FIG. 4 depicts one embodiment of interlocking wagon 100 when first component 110 and second component 120 are coupled together. As depicted in FIG. 4, when coupled together, projections 220 may be positioned under and adjacent to grooves 320. Accordingly, a first end of interlocking wagon 100 may be secured together by interfacing projections 220 and grooves 320. The second end of interlocking wagon 100 may be coupled tougher via the locking mechanisms and lock receivers.

In embodiments that include a second handle, the second handle may project away from the first end of interlocking wagon 100. In embodiments, the distance between the second handle and the ends of second component 120 may be greater than the depth of front sidewall 216 and rear sidewall 218. Accordingly, to decouple first component 110 and second component 120 from each other, it may be required to align the depth of rear sidewall 216 with the opening at the end of second component 120.

Additionally, the distance across the second handle may be greater than the distance across arms 218 but less than the distance across projections 220. This may allow arms 218 to slide within the opening across second handle 314 when first component 110 is tilted.

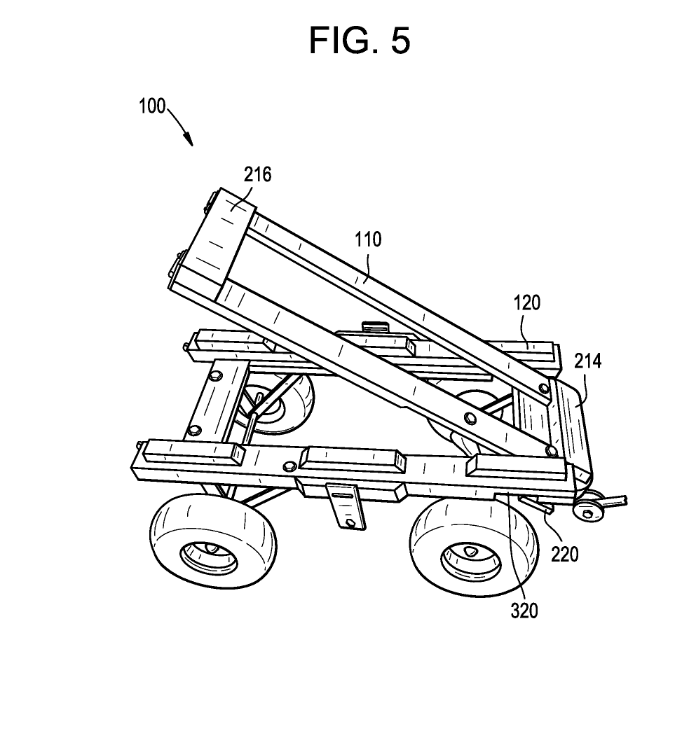

FIG. 5 depicts one embodiment of decoupling first component 110 and second component 120 of interlocking wagon 100.

As depicted in FIG. 5, to decouple the first component 110 and second component 120, first components 110 may initially be tilted to slide out of second component 120. More specifically, the first end of first component 110 may be tilted downward, such that front sidewall 214 may be positioned below grooves 320. When front sidewall 214 is positioned below grooves 220, arms 218 may slide out of opening 314. If first component 110 is not tilted, the portion of rear sidewall 216 is positioned adjacent to rear platform 316 may limit the forward movement of first component 110.

In embodiments with a second handle, when decoupling first component 110 and second component 120, responsive to lowering first end of first component 110 away from the second handle 314, projections 220 may be moved away from grooves 320, and be positioned away from the second handle. Because arms 218 have a narrower width than the distance across the second handle, arms 218 may slide through the opening formed between the second handle and grooves 316.

More so, because rear sidewall 216 has a width that is greater than the width of side platforms 318, rear sidewall 216 may not be able to slide out of second component 120 outside of an area between the second handle and side platforms 318. This may further enable the coupling of first component 110 and second component 120.

Yet, responsive to tilting both first component 110 and second component 120 so their respective wheels are adjacent to a floor surface and their opposite ends are raised, rear sidewall 216 may be aligned with the opening between the second handle and side platforms 318. When aligned, rear sidewall 216 may pass through the opening, such that the entirety of first component 110 and second component 120 may be decoupled.

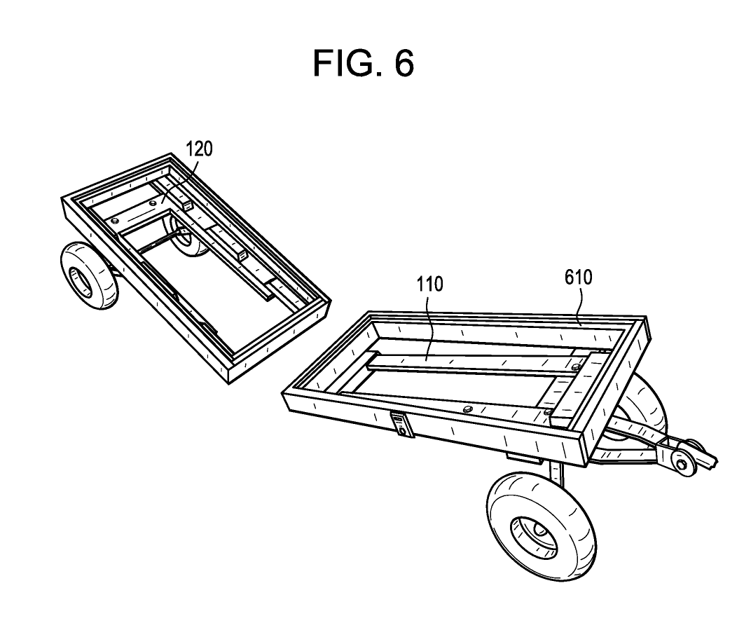

FIG. 6 depicts one embodiment of first component 110 and second component 120 of interlocking wagon 100 being completely separated. As depicted in FIG. 6, boards 610, planks, etc. may be positioned over first component 110 and second component 120 to create a tailgating game. Furthermore, the tilt angle of both first component 110 and second component 120 may be the same due to the heights of the wheel sets being the same, and the handles extending away from a body of first component 110 and second component 120 at the same distance.

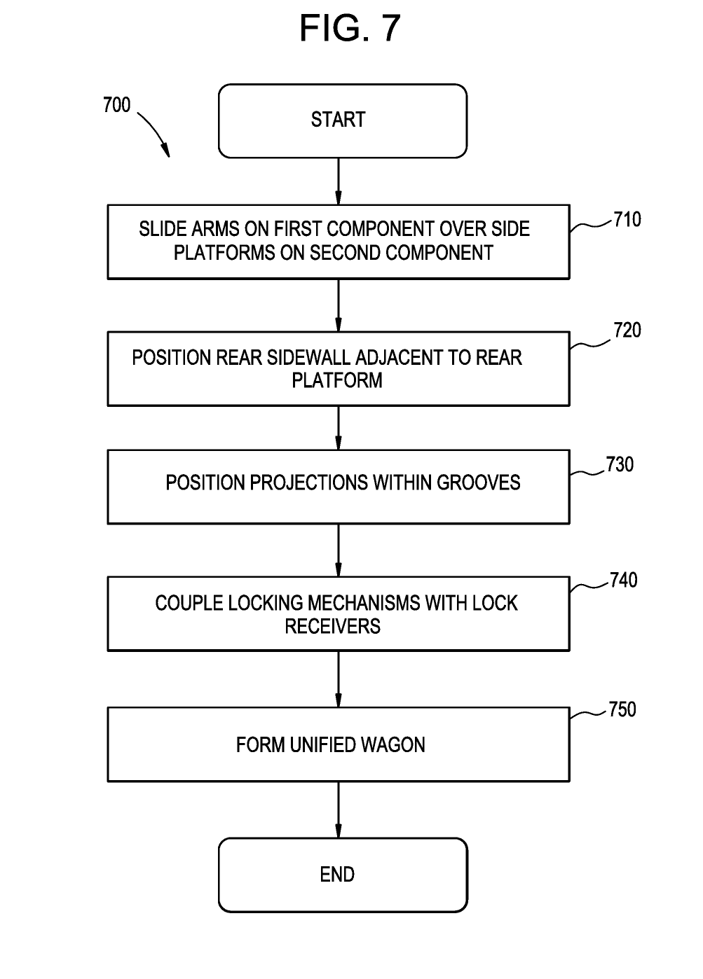

FIG. 7 depicts a method 700 for coupling components of an interlocking wagon. The operations of method 700 presented below are intended to be illustrative. In some embodiments, method 700 may be accomplished with one or more additional operations not described, and/or without one or more of the operations discussed. Additionally, the order in which the operations of method 700 are illustrated in FIG. 7 and described below is not intended to be limiting.

At operation 710, a first component of an interlocking wagon may be tilted, and arms on the first component may be positioned over and adjacent to side platforms on the second component.

At operation 720, responsive to sliding the first component over the second component of the interlocking wagon, a rear sidewall of the first component may positioned an area between a a second end of the second component and side platforms. A front portion of the rear sidewall on the first component may be positioned adjacent to a rear platform on the second component to limit the forward movement of the first component.

At operation 730, responsive to the rear sidewall of the first component being at the second end of the second component, projections on the first component may interface with grooves on the first end of the second component.

At operation 740, locking mechanisms positioned on the second end of the second component may be inserted into lock receivers positioned on the rear sidewall of the first component. Responsive to inserting the locking mechanisms into the lock receivers, the first component may be coupled to the second component.

At operation 750, the interlocking wagon may form a unified wagon, and may be transported from a first location to a second location.

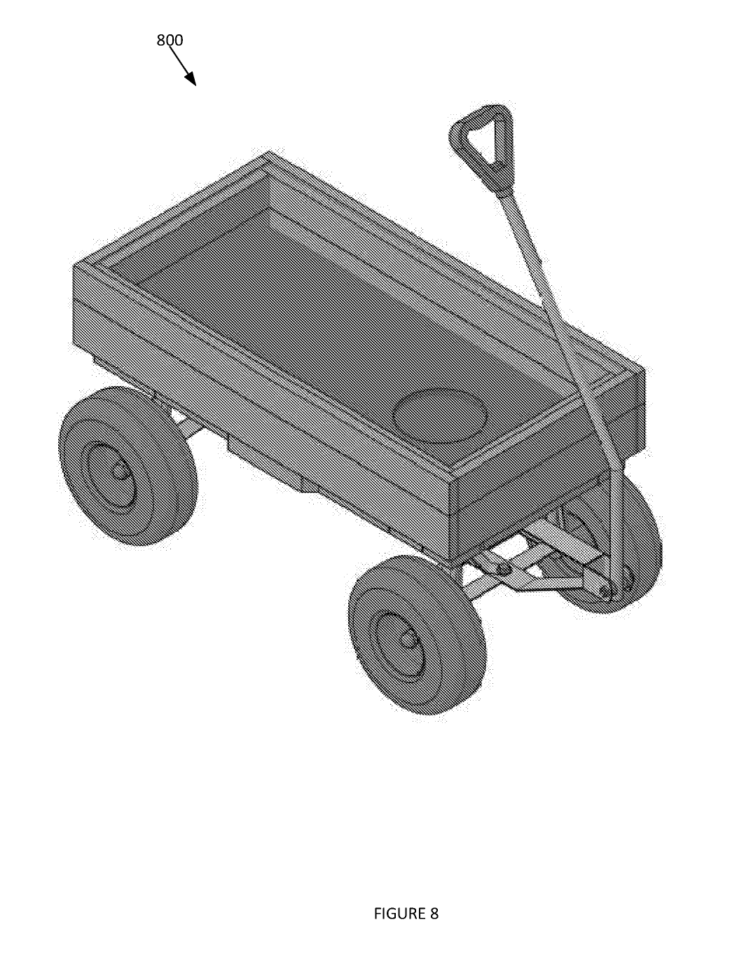

FIG. 8 depicts a fully assembled wagon 800, according to an embodiment.

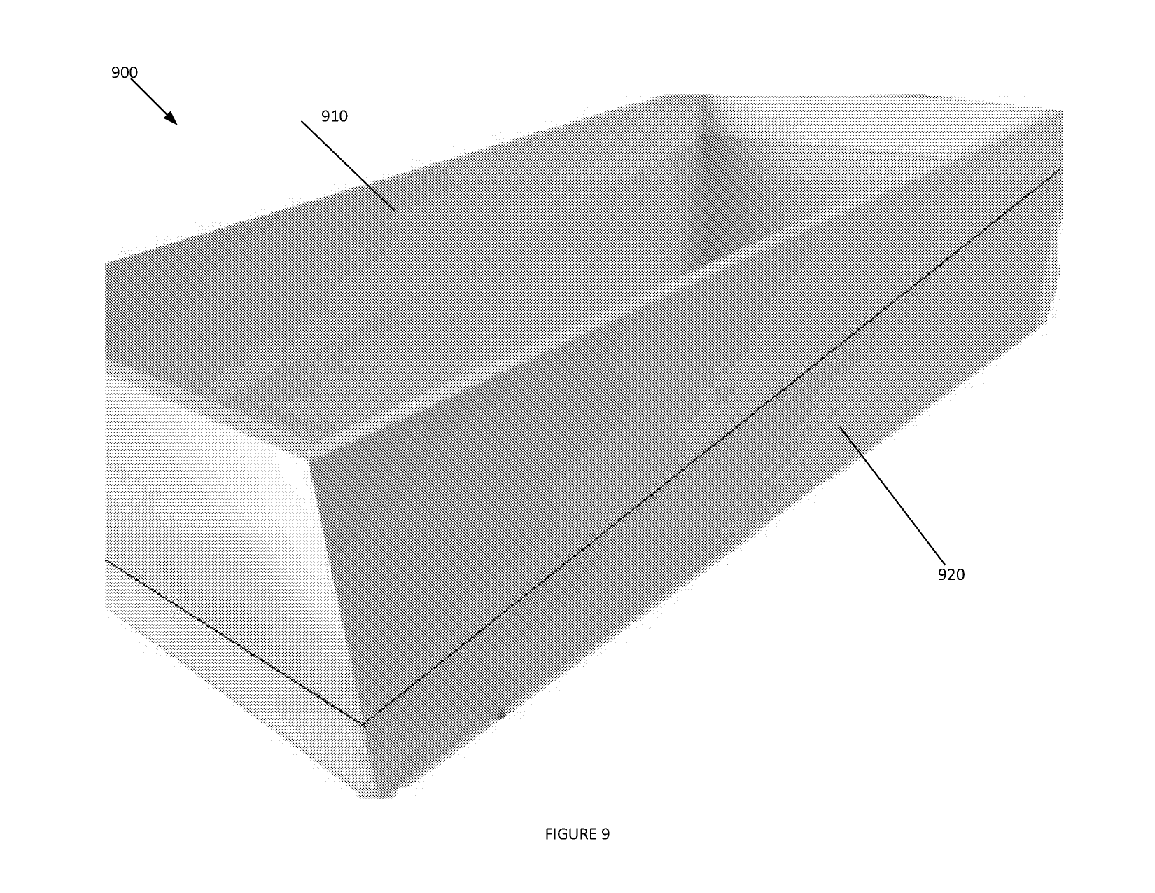

FIG. 9 depicts side rail 900 associated with an integrated wagon. Side rails 900 may be configured to be positioned over a flatbed wagon, while the wagon is still functioning. Side rails 900 may be comprised of two independent parts 910, and 920. The two independent parts 910, 920 may have symmetrical, tapered, and supplementary sidewalls. Responsive to positioning a first part 910 on top of second part 920, a rectangular box may be formed. Responsive to separating the two parts 910, 920, two independent game parts may be formed with angled top surfaces and planar bottom surfaces.

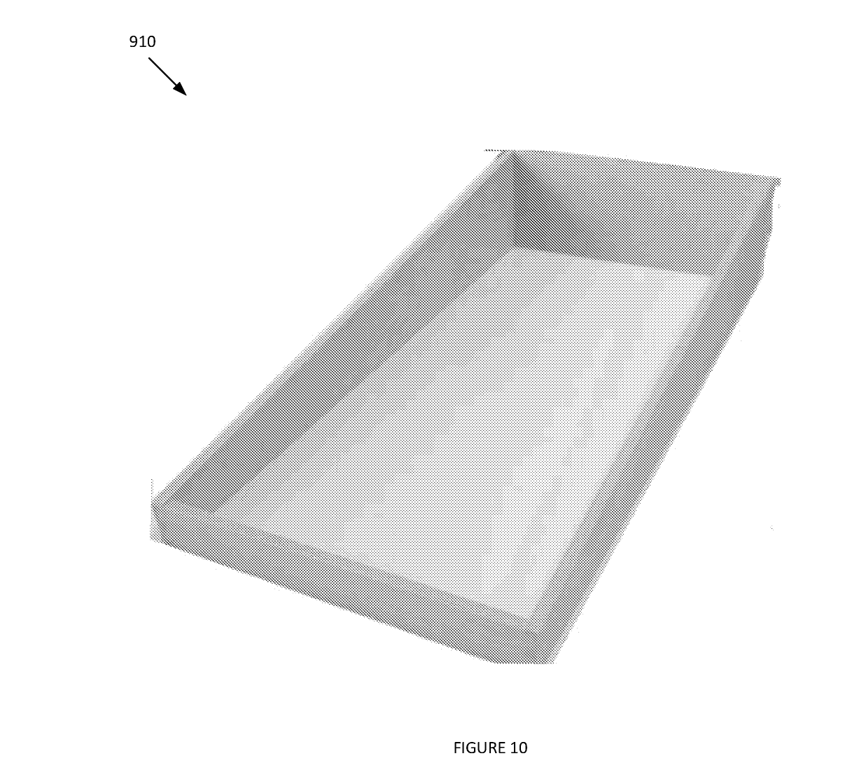

FIG. 10 depicts a first part 910 of side rails 900. As depicted in FIG. 10, first part 910 may have a planar bottom surface, and may have angled sidewalls that increase in height from the front to back of first part 910.

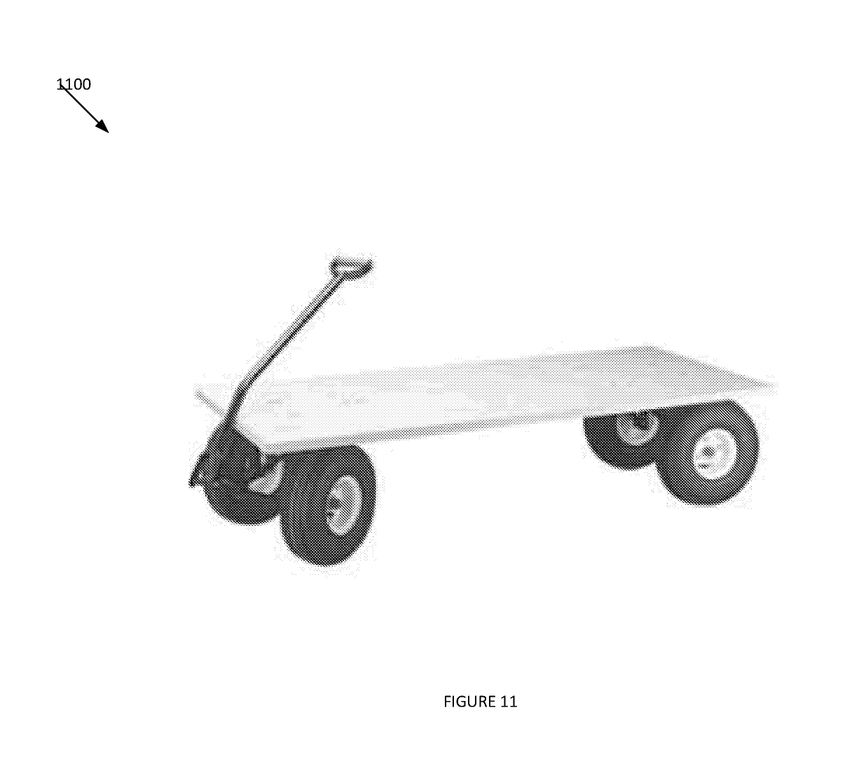

FIG. 11 depicts a flatbed wagon 1100, according to an embodiment. Flatbed wagon 1100 may be configured to transport side rails 900, wherein side rails 900 may be stacked on the flatbed of flatbed wagon 1100.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

What is claimed is:

1. An interlocking wagon comprising:
a first component with a first set of wheels, a front sidewall, a rear sidewall, arms, and projections, the front sidewall being positioned on a first end of the first component, the rear sidewall being positioned on a second end of the first component, the arms including a first width and extending from the front sidewall to the rear sidewall, and the projections being positioned proximate to the front sidewall and extending away from an outer surface of the arms;
a second component including a second set of wheels, side platforms, and grooves, the side platforms having a second width and extending from a third end to a fourth end, wherein the arms are configured to be positioned adjacent to the side platforms, the second width being larger than the first width, the grooves being positioned on a lower surface of the side platforms proximate to the fourth end, wherein the projections are configured to be inserted into the grooves.

2. The system of claim 1, wherein the second component includes a handle positioned on the fourth end, an opening being formed between an end of the second component and the handle.

3. The system of claim 2, wherein a length of the opening is greater than a depth of the rear sidewall.

4. The system of claim 1, wherein the rear sidewall includes a third width, the third width being greater than the second width.

5. The system of claim 1, wherein the first component is configured to be removably coupled with the second component.

6. The system of claim 5, wherein when the first component and the second component are decoupled, the first component and the second component are independent components.

7. The system of claim 1, wherein the first component and the second component are asymmetrical.

8. The system of claim 1, wherein the third end of the second component includes slots, the slots being positioned on an upper surface of the side platforms, and the slots being configured to receive the rear sidewall.

9. The system of claim 1, wherein when the first component and the second component are coupled together, the arms extend in a direction in parallel to a floor surface.

10. The system of claim 1, wherein when the first component and the second component are decoupled from each other, the arms and the side platforms are tilted at a downward angle.

11. A method of removably coupling an interlocking wagon system, the method comprising:
tilting a first component of the interlocking wagon system;
tilting a second component of the interlocking wagon system;
aligning a rear sidewall of the first component with an opening between side platforms on the second component and a handle on the second component;
sliding arms of the first component adjacent to an inner surface of the side platforms, the arms including a first width and extending from a front sidewall on a first end of the first component to the rear sidewall on a second end of the first component, the side platforms extending from a third end to a fourth end and including a second width, the second width being greater than the first width;
interfacing projections on the first component with grooves on a lower surface of the side platforms proximate to the fourth end, the projections being positioned proximate to the front sidewall and extending away from an outer surface of the arms.

12. The method of claim 11, wherein the second component includes a handle positioned on the fourth end, an opening being formed an end of the second component and the handle.

13. The method of claim 12, wherein a length of the opening is greater than a depth of the rear sidewall.

14. The method of claim 11, wherein the rear sidewall includes a third width, the third width being greater than the second width

15. The method of claim 11, further comprising:
coupling the first component with the second component.

16. The method of claim 11, further comprising:
decoupling the first component with the second component, wherein when the first component and the second component are decoupled the first component and the second component are independent components.

17. The method of claim 11, wherein the first component and the second component are asymmetrical.

18. The method of claim 11, wherein the third end of the second component includes slots positioned on an upper surface of the side platforms;
receiving, via the slots, the rear sidewall.

19. The method of claim 11, further comprising:
positioning the arms and the side platforms in a direction in parallel to a floor surface when the first component and the second component are coupled together.

20. The method of claim 11, further comprising:
tilting the arms and the side platforms at a downward angle when the first component and the second component are decoupled from each other.
